(19) United States
(12) Patent Application Publication
(10) Pub. No.: US 2017/0082516 A1
(43) Pub. Date: Mar. 23, 2017

(54) INTERNAL COMBUSTION ENGINE AND METHOD FOR DETECTING OPERATING CONDITIONS OF AN INTERNAL COMBUSTION ENGINE

(71) Applicant: SCANIA CV AB, Södertälje (SE)

(72) Inventors: Ola STENLÄÄS, Södertälje (SE); Mikael NORDIN, Järna (SE)

(21) Appl. No.: 15/312,215

(22) PCT Filed: Jun. 16, 2015
(86) PCT No.: PCT/SE2015/050693

§ 371 Date: Nov. 18, 2016

(30) Foreign Application Priority Data
Jun. 17, 2014 (SE) 1450746-1

(51) Int. Cl. G01L 23/10; F02D 41/04; F02D 41/26; F02D 35/02

(52) U.S. Cl. CPC G01L 23/10; F02D 35/022; F02D 35/024; F02D 41/04; F02D 41/26

(57) ABSTRACT

A combustion engine with a device adapted to detect operating conditions in the engine, and which device has a device with at least one sensor element, arranged separately from a cylinder chamber on a cylinder head of a cylinder in the engine. The sensor element is adapted to detect propagated movements in the cylinder head or in parts adjacent thereto, generated by pressure changes in said cylinder chamber.

### CROSS-REFERENCE TO RELATED APPLICATION(s)

This application is a national stage application (filed under 35 § U.S.C. 371) of PCT/SE15/050693, filed Jun. 16, 2015 of the same title, which, in turn claims priority to Swedish Application No. 1450746-1, filed Jun. 17, 2014 of the same title; the contents of each of which are hereby incorporated by reference.

### FIELD OF THE INVENTION

The present invention relates to a combustion engine comprising a device adapted to detect operating conditions of the engine, and which device comprises a device adapted to detect pressure changes in the cylinder chamber of at least one cylinder in the engine, and a method to detect pressure changes in the cylinder chamber of at least one cylinder in the engine.

### BACKGROUND OF THE INVENTION

There is a constant aspiration to achieve control of a combustion engine, in such a manner that fuel used therein is burned in the engine's cylinders, while generating a maximum amount of energy/fuel mass output from the engine and a minimum amount of emissions. It is of decisive importance in such aspiration to have constant knowledge of the combustion engine's operating conditions. The pressure changes that take place during operation in the cylinder chambers of such an engine's cylinders contain valuable information about the engine's operating conditions.

In order to access such information, combustion engines have been equipped with said devices which have included pressure sensors reaching into said cylinder chambers, via holes bored through the engine walls, in order to detect the pressure inside the cylinder chamber.

### SUMMARY OF THE INVENTION

The objective of the present invention is to provide a combustion engine and a method, which are improved in at least one respect in relation to prior art such combustion engines and methods.

Surprisingly, it has become apparent that when a sensor element is placed on a part of a cylinder head or on parts adjacent thereto in the engine, for example adjacent to the cylinder, but outside the cylinder, for example adjacent to the outlet from the cylinder or adjacent to inlet channel to the cylinder, movements or vibrations, generated by pressure changes in said cylinder chamber, and propagating in said cylinder head or said parts, may be detected, and as a result indirect pressure changes in the cylinder chamber may be detected in a reliable manner. Thus, e.g. the development of the gas pressure over time in the cylinder chamber of the relevant cylinder in the engine may be reliably derived. Accordingly, this is possible without any holes having to be bored in the combustion chamber, and in addition to a cost saving thus achieved, through the invention disruptions, which pressure sensors inserted into the cylinder chamber may cause, are also avoided.

The movements which in this manner may be detected, and which are generated by pressure changes in a cylinder chamber (combustion chamber), may for example be vibrations, noise, i.e. gas movements, various types of shape changes, such as protrusions, in said cylinder head or in parts adjacent thereto in the engine.

The fact that said at least one sensor element is arranged separately from the cylinder chamber, i.e. the cylinder's combustion chamber, means that it does not participate in any direct contact with the inside volume of the cylinder chamber, but is completely separate therefrom. However, some form of external recess could be adapted in the wall of the cylinder chamber, in which a sensor element could be arranged.

According to one embodiment of the invention, said sensor element is arranged inside or on said cylinder head. Such a placement of the sensor element, preferably near the top dead center of the cylinder's piston, has been shown to be advantageous for purposes of ensuring that easily readable signals with minor noise reach the sensor element.

According to another embodiment of the invention, said sensor element is adapted to detect movements with a frequency of 250 Hz, 0.5 Hz-250 Hz or 0.5 Hz-200 Hz, i.e. large-scale movements. The sensor element is in this case adapted to detect movements occurring with relatively low frequency, and the basic frequency of the gas pressure variation inside said cylinder chamber lies within these intervals, which is the same as the engine speed of the combustion engine, which may e.g. typically be 60 revolutions per minute (1Hz) for a marine diesel engine and as high as 12 000 revolutions per minute (approximately 200 Hz) for an Otto engine in a motorcycle. Since the sensor element is adapted to detect movements within these frequency areas, useful information about the combustion engine's operating conditions may be extracted from the information about the movements attributable to the pressure changes in the cylinder chamber. The sensor element may in another embodiment be arranged to detect higher frequencies. Such higher frequencies may be in the range of kHz. For example, the sensor element may be arranged to detect frequencies in the range of 1 kHz-20 kHz. Other frequency areas or combinations of frequency areas may be detected depending on the application.

According to another embodiment of the invention, the engine has a cylinder head which is common to several cylinders in the engine, and said device has at least one said sensor element placed and adapted to detect and differentiate movements derived from pressure changes in several said cylinder chambers. Thanks to this suitable placement of a sensor element in a combustion engine with such a cylinder head, information may thus be obtained from pressure changes in several cylinder chambers with the use of only one sensor element, and thus a cost saving is achieved.

According to another embodiment of the invention, said device comprises several sensor elements adapted to separately together detect movements generated by pressure changes in all the cylinder chambers in the engine. By detecting such movements derived from pressure changes separately in each one of the cylinder chambers of the engine, voluminous information may be obtained about the engine's operating conditions, leading to suitable measures in the combustion engine's different control systems, diagnoses and similar.

According to another embodiment of the invention, the engine has a cylinder head for each cylinder in the engine, and the device comprises a separate said sensor element for each cylinder in the engine.

According to another embodiment of the invention, said sensor element is adapted to detect said movement optically or via piezo electricity or resistivity. These are some types of suitable sensor elements for detection of movements derived from pressure changes in the cylinder chamber, when placed on a part of a cylinder head or on parts adjacent thereto in a combustion engine.

According to another embodiment of the invention, said device comprises a unit adapted to receive information about said detected movements from said sensor element, to process them, and to compare such information with values stored in the engine for the relevant operating conditions and, based thereon, to deliver measured values relating to performance and/or the state of the engine and/or processes in the engine. Via such comparisons, it becomes possible to obtain valuable information, based on the movements detected by said sensor elements, about the combustion engine's operating condition, in order to use these in a suitable manner.

The above mentioned objective is achieved in relation to the method by way of carrying out the detection, in a method of the type defined above, by detecting movements in a cylinder head or in parts adjacent thereto in the engine, generated by pressure changes in said cylinder chamber. The discussion above about the different embodiments of the innovative combustion engine identifies what may be achieved thanks to such a method and the advantages thereof.

According to one embodiment of the invention, a development over time of the gas pressure in the cylinder chamber of at least one cylinder in the engine, a so-called cylinder pressure curve, is calculated, based on information of said detected movements. It has been shown that such a cylinder pressure curve may be produced based on said detected movements.

According to another embodiment of the invention, a measured value of an amount of heat released in at least one cylinder of the engine is calculated, based on information of said detected movements. For example, the heat amount may be calculated by integrating the heat release (dQ), which is obtained from the pressure volume change corrected for losses.

dQ=((Cp/Cv)/((Cp/Cv)−1))*P*dV+1/((Cp/Cv)−1)*V*dP+losses).

Losses are typically heat losses and leakage of gas from the cylinder.

The invention also relates to a computer program, a computer program product, an electronic control device and a motor vehicle arranged to use the combustion engines and methods described herein.

Additionally, the invention relates to a device adapted to detect the operating conditions in a combustion engine. The function of such a device and the possibilities it offers is described in the discussion above of the innovative combustion engine.

The invention is not limited to any specific type of combustion engine, but encompasses Otto engines as well as compression ignited engines, nor to any specific fuel, non-exhaustive examples of which may comprise fuel in the form of petrol, ethanol, diesel and gas.

Likewise, the invention comprises combustion engines intended for all types of use, such as in industrial applications, in crushing machines and various types of motor vehicles, wheeled motor vehicles as well as trucks and buses, and boats and crawlers or similar vehicles.

Other advantageous features and advantages with the invention are set out in the description below.

### BRIEF DESCRIPTION OF THE DRAWINGS

Below are descriptions of example embodiments of the invention, with reference to the enclosed drawings, in which:

FIGS. 1a, b are a schematic view illustrating a part of a combustion engine according to one embodiment of the invention,

FIG. 2a is a magnified view of a part of the combustion engine in FIG. 1, illustrating the arrangement of a sensor element on a cylinder head of the engine,

FIG. 2b is a view of a part of the combustion engine with the sensor element arranged in an adjacent part, here arranged on the engine, in an area in connection with the outlet of the exhaust channel from a cylinder,

FIG. 3 is a diagram showing the pressure in the cylinder chamber of a cylinder in a combustion engine according to the invention over time, and a signal over time generated by a sensor element according to FIG. 2a or 2b in the combustion engine, as a result of detection of movements in the cylinder head,

FIG. 4 is a view corresponding to that in FIG. 1 of a combustion engine according to a second embodiment of the invention, and

FIG. 5 is a diagram of an electronic control device for the implementation of a method according to the invention.

### DETAILED DESCRIPTION OF THE INVENTION

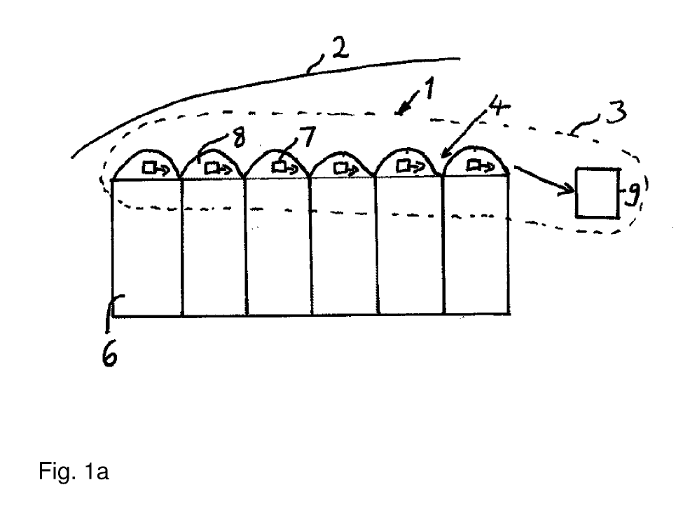

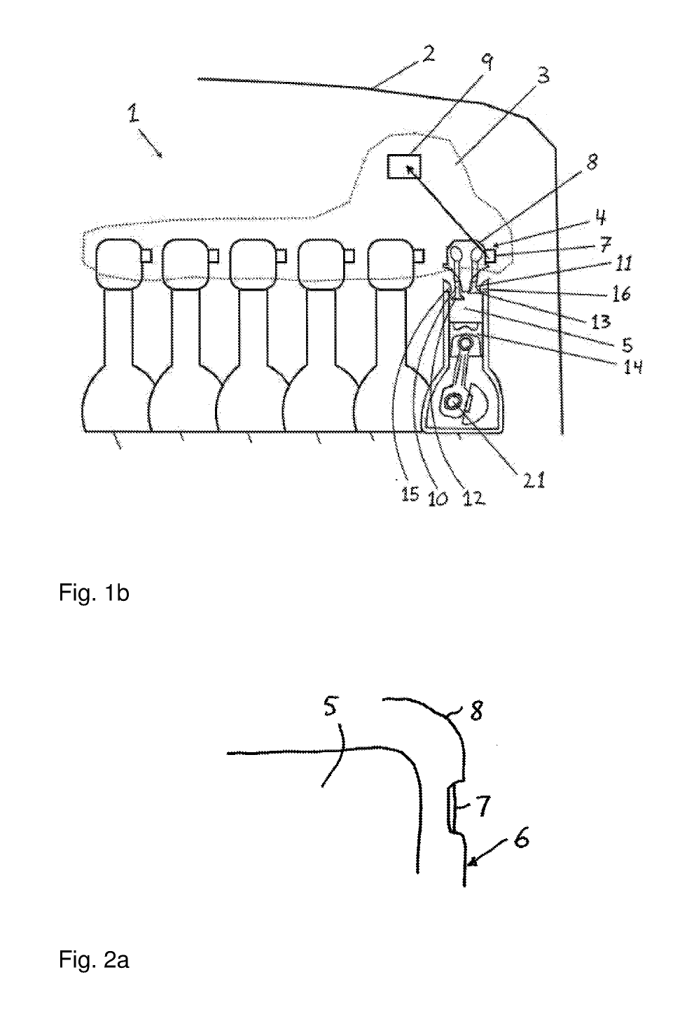

FIGS. 1a and 1b illustrate very schematically a combustion engine 1 according to one embodiment of the invention, which is here arranged in an implied motor vehicle 2, for example a truck. The engine is equipped with a device 3, indicated with a dashed line, adapted to detect operating conditions in the engine, and such device has a schematically drawn device 4, which is adapted to detect pressure changes in the cylinder chambers 5 of the combustion engine's cylinders 6, of which there are six in this case, but of which there may be any number. Each cylinder 6 comprises a piston 14, arranged to operate a crankshaft 12, an inlet valve 10, which controls the gas in-flow from an inlet channel 15 to the cylinder's combustion chamber 5, and an exhaust valve 11, which controls the outflow of exhausts via an exhaust channel 16.

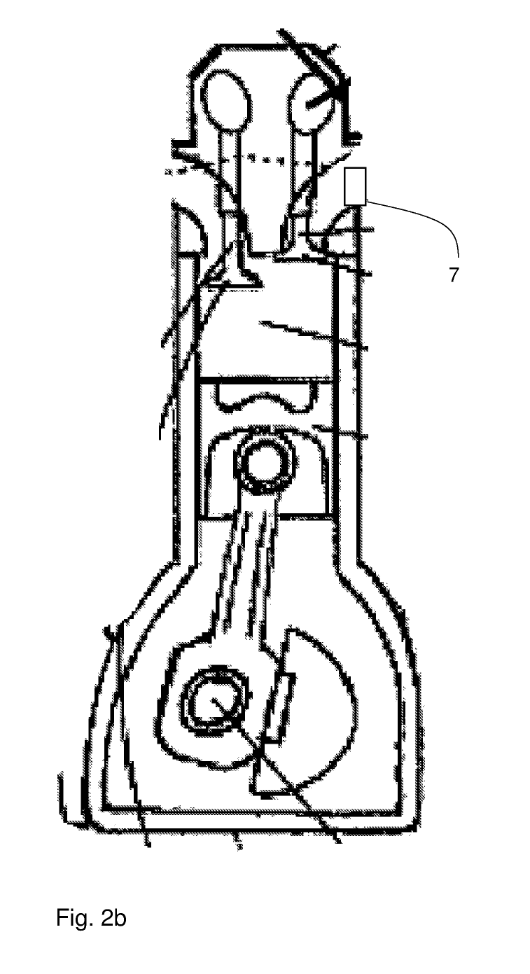

The device 4 has, in order to be able to detect said pressure changes in the cylinder chambers, one sensor element 7 per cylinder 6, and this is arranged separately from the one belonging to the cylinder chamber 5 on the cylinders' cylinder heads 8. The sensor elements are here piezo resistive sensors, adapted to detect propagating movements, for example in the form of vibrations, generated by pressure changes in the relevant cylinder chambers. FIG. 2a shows how such a piezo resistive sensor element 7 is arranged in the cylinder head 8.

The device 3 also comprises a unit 9, which may consist of the vehicle's electronic control device, adapted to receive information about the detected movements from the sensor elements 7 and to compare such information, or of information calculated based on such sensor information, with values stored in relation to the desired operating conditions in the engine, and based on such comparison, to deliver measured values for the performance and/or state and/or processes in the engine, such as pressure increases in the relevant cylinder. Thus, information about the engine's operating conditions or divergences from these, which suitably provide the bases for control of various components in the combustion engine, such as for example fuel injection, may be obtained, based on the sensor elements' detection.

It has been shown that, by arranging such sensor elements in the manner described, so that they have the ability to detect movements propagating in the cylinder head or in parts adjacent thereto in the engine, derived from pressure changes in the cylinder chamber, high quality signals may be obtained, which signals do not require filtering or further processing, or alternatively, which require a simple filtering or processing, to function as measured values for pressure changes in the relevant cylinder chamber. In one embodiment, the sensor elements are preferably adapted to detect movements, which propagate in the relevant cylinder head or in parts adjacent thereto in the engine with a relatively low frequency, for example within the interval 0.5 Hz-250 Hz, when large-scale movements is to be detected. In other applications, movements or vibrations with a higher frequency, for example in the kHz region, are detected with the help of the sensor element.

FIG. 2b shows another placement of the sensor element. The sensor element is here placed on a section adjacent to the cylinder head. In this example, the sensor element is placed on the engine, specifically on the engine block. The sensor element may here be placed on the engine, in an area adjacent to the outlet of the exhaust channel from a cylinder. For example on a surface on the engine block next to the outlet, on the engine, of the exhaust channel from a cylinder. The surface where the sensor is placed may be substantially vertical. The sensor may be arranged to detect movements, which are perpendicular to the movements of the piston. The sensor may also be arranged to detect movements, which are perpendicular both in relation to the piston's direction of movement and in relation to the engine's longitudinal direction. In one embodiment, the sensor is located on the engine's long side. The sensor may be arranged to detect movements in a direction, which is perpendicular in relation to the surface on which it is placed.

In another embodiment (not displayed) the sensor element may be placed in a corresponding manner as when placed on the engine at the outlet of the exhaust channel from a cylinder, but instead placed in a corresponding location on the engine, at the suction channel's inlet to a cylinder.

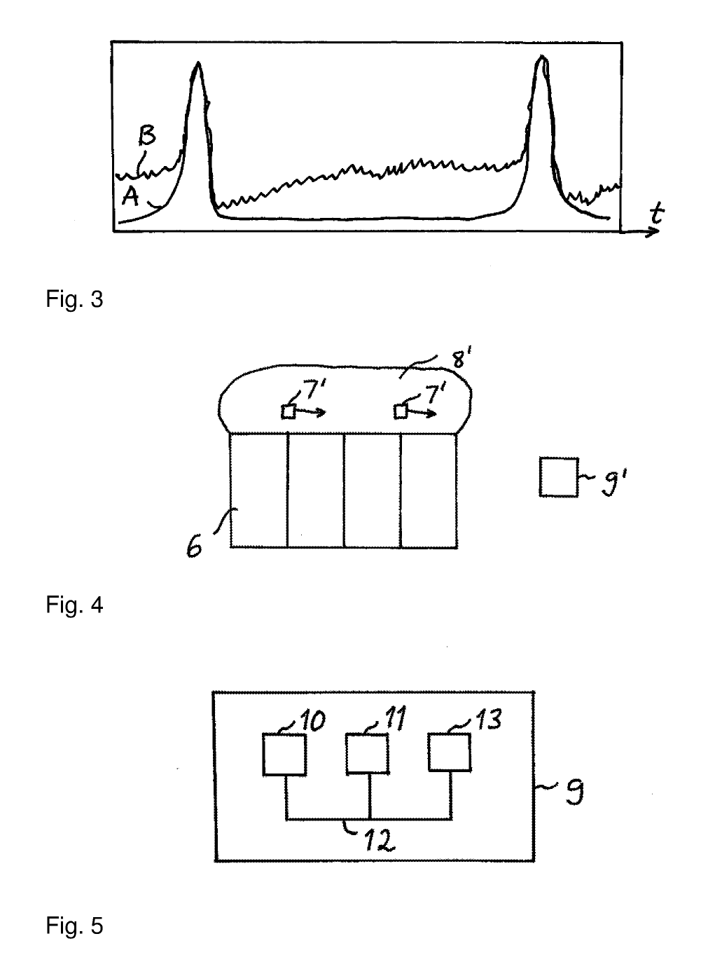

FIG. 3 illustrates the development of the pressure A over the time t in a cylinder chamber of a compression ignited engine, which uses diesel as fuel during operation. The gas pressure A in the cylinder chamber was measured with a conventional pressure sensor. The same diagram shows the development of a signal B over the time t, obtained by a sensor element 7 arranged in the manner illustrated in FIGS. 1 and 2, separately from the cylinder chamber on the cylinder's cylinder head. This diagram shows that the signal B, derived from the sensor element, describes pressure changes arising in the cylinder chamber very well, and these pressure changes here consist of the pressure increases that take place when the cylinder's piston is near its upper dead center. The movements detected, derived from the movements of the piston in the cylinder chamber, accordingly have the same frequency as the engine's working frequency or engine speed. However, movements derived from pressure changes in the cylinder chamber, other than such changes generated by the piston's movement, may be detected to draw conclusions about the combustion engine's operating state based thereon. Accordingly, with the help of the innovative device, a development over time of the gas pressure in the cylinder chamber of the respective cylinder in the engine, a so-called cylinder pressure curve, may be calculated or estimated, based upon the information obtained from the movements detected by the sensor elements. By way of information from such detection, the amount of heat released in the respective cylinder may also be calculated. In some embodiments, the entire cylinder pressure curve is estimated in this manner. In some embodiments only a part of the cylinder pressure curve is estimated. For example, the cylinder pressure curve may be estimated only during the phase when the pressure in the cylinder increases.

The sensor elements 7 of the innovative device could also be supported by other sensors, such as sensors measuring the charge air pressure, the exhaust engine pressure, the crankshaft angle, etc. in order to obtain information from the unit 9 about the engine's operating conditions, which information may be used to control different components in the engine. Such information as is stored in a memory device may also be obtained, and may then be considered at future service or maintenance of the engine. If said data is of a more serious type, i.e. is suggesting some serious malfunction in a component of the engine, they may also cause a direct emission of an alarm signal.

FIG. 4 illustrates schematically how the invention may be realized for a combustion engine with a single, common cylinder head 8′ for all cylinders 6′, here four in number. Equivalent components in the embodiment in FIG. 1 have been designated with the same reference with an added. In this embodiment there are two sensor elements 7′, each one adapted to detect movements propagating in the cylinder head 8′ and deriving from pressure changes in the cylinder chambers of the two cylinders 6′ placed nearest the sensor element.

The signal detected by the sensor may be treated in various ways. For example, the following signal treatment steps may be carried out. First the sensor's electrical signal is entered into a control device/signal treatment device. The signal is filtered with a bandpass filter, in order to remove superfluous information which does not belong to the frequency range around which information is required. The signal is evened out by way of filtering, averaging or by being replaced with one or several continuous function(s) with good likeness. Subsequently, the signal is scaled, e.g. with the help of the correlation between pressure and volume at compression. Subsequently, (a) suitable part(s) of the signal is/are transformed to the pressure domain. Supplemental modeling closes gaps in the signal's reliability, in order to form a pressure curve. The pressure curve thus created is used to calculate different values at engine control, e.g. Start of Combustion, SOC, different crank angles at a certain amount of burned fuel, for example 10%, 50% and 90% (CA10, CA50, CA90), End of Combustion, EOC, Indicated Mean Effective Pressure; IMEP and maximum pressure Pmax. In some embodiments one or several of the steps above may be omitted.

A computer program code for the implementation of a method according to the invention is suitably included in a computer program, loadable into the internal memory of a computer, such as the internal memory of an electronic control device of a combustion engine. Such a computer program is suitably provided via a computer program product, comprising a data storage medium readable by an electronic control device, which data storage medium has the computer program stored thereon. Said data storage medium is e.g. an optical data storage medium in the form of a CD-ROM, a DVD, etc., a magnetic data storage medium in the form of a hard disk drive, a diskette, a cassette, etc., or a Flash memory or a ROM, PROM, EPROM or EEPROM type memory.

FIG. 5 very schematically illustrates an electronic control device 9 comprising execution means 10, such as a central processor unit (CPU), for the execution of computer software. The execution means 10 communicates with a memory 11, e.g. a RAM memory, via a data bus 12. The control device 9 also comprises a data storage medium 13, e.g. in the form of a Flash memory or a ROM, PROM, EPROM or EEPROM type memory. The execution means 10 communicates with the data storage means 13 via the data bus 12. A computer program comprising computer program code for the implementation of a method according to the invention is stored on the data storage medium 13.

The invention is obviously not limited in any way to the embodiments described above, but numerous possible modifications thereof should be obvious to a person skilled in the area, without such person departing from the spirit of the invention as defined by the appended claims.

For example, the combustion engine could have another number of cylinders than displayed. A sensor element to detect movements derived from the cylinder chambers in all cylinders is also unnecessary, and it is even plausible that the device may have only one sensor element, intended to detect movements derived from pressure changes in only one of the engine's cylinders.

The sensor elements may be adapted to detect said movements also when there is no combustion in the engine's cylinders, but when there are still changes in the pressure inside the cylinder chambers, for example when starting the combustion engine with a starting engine.

1. A combustion engine comprising a device arranged to detect operating conditions of the engine, and which device comprises:
a device adapted to detect pressure changes in a cylinder chamber of at least one cylinder in the engine;
at least one sensor element, arranged separately from said cylinder chamber on a part of a cylinder head or on parts adjacent thereto in the engine, and adapted to detect propagated movements in said cylinder head or said parts, generated by pressure changes in said cylinder chamber.

2. An engine according to claim 1, wherein said sensor element is arranged in or on said cylinder head.

3. An engine according to claim 1, wherein said sensor element is placed on the engine, in an area adjacent to the outlet of the exhaust channel from a cylinder.

4. An engine according to claim 1, wherein said sensor element is placed on the engine, in an area adjacent to the inlet of the inlet channel to a cylinder.

5. An engine according to claim 3, wherein said sensor element is placed on the engine block.

6. An engine according to claim 5, wherein said sensor element is placed on a substantially vertical surface.

7. An engine according to claim 6, wherein said sensor element is arranged to detect movements in a direction substantially perpendicular in relation to the piston's movement direction.

8. An engine according to claim 6, wherein said sensor element is arranged to detect movements in a direction substantially perpendicular in relation to the engine's longitudinal direction.

9. An engine according to claim 1, wherein said sensor element is adapted to detect movements with a frequency of ≦250 Hz, 0.5 Hz-250 Hz or 0.5 Hz-200 Hz.

10. An engine according to claim 1, wherein it has a cylinder head, which is common to several cylinders in the engine, and that said device has at least one said sensor element placed and adapted to detect and differentiate movements derived from pressure changes in several of said cylinder chambers.

11. An engine according to claim 1, wherein said device comprises several sensor elements, adapted to separately together detect movements generated by pressure changes in all the cylinder chambers of the engine.

12. An engine according to claim 11, wherein it has a cylinder head for each cylinder in the engine, and in that the device comprises a separate said sensor element for each cylinder in the engine.

13. An engine according to claim 1, wherein said sensor element is adapted to detect said movements optically or via piezo electricity or piezo resistivity.

14. An engine according to claim 1, wherein said device comprises a unit, adapted to receive information about said detected movements from said sensor element, to process them, and to compare such information with values stored for the relevant operating condition of the engine, and based thereupon to deliver measured values for performance and/or condition of the engine and/or processes in the engine.

15. An engine according to claim 1, wherein said device comprises a device adapted to generate a pressure curve corresponding to the pressure in a cylinder during a cylinder cycle.

16. An engine according to claim 15, wherein the pressure in a cylinder is determined only when the pressure inside the cylinder increases.

17. A method for detection of operating conditions in a combustion engine, comprising the step of detecting pressure changes in a cylinder chamber of at least one cylinder in the engine, wherein the detection occurs by way of detecting movements of a cylinder head or of parts adjacent thereto in the engine, generated by pressure changes in said cylinder chamber.

18. A method according to claim 17, wherein said detection occurs with a sensor element arranged in or on said cylinder head.

19. A method according to claim 17, wherein said detection occurs with a sensor element placed on the engine, in an area adjacent to the outlet of the exhaust channel from a cylinder.

20. A method according to claim 17, wherein said detection occurs with a sensor element placed on the engine, in an area adjacent to the inlet to the inlet channel to a cylinder.

21. A method according to claim 17, wherein movements with a frequency ≦250 Hz, 0.5 Hz-250 Hz or 0.5 Hz-200 Hz are detected.

22. A method according to claim 17, further comprising the step of comparing information in the detected movements, or in a processed form of these, with stored values for the relevant operating conditions in the engine, and based upon such comparison to deliver measured values for performance and/or condition of the engine and/or processes in the engine.

23. A method according to claim 17, wherein a development over time of the gas pressure in the cylinder chamber during a working cycle of at least one cylinder of the engine, a so-called cylinder pressure curve, is calculated, based on information in said detected movements.

24. A method according to claim 17, wherein a measured value of a heat amount released in at least one cylinder of the engine, as a function of the crank angle, is calculated, based on information in said detected movements.

25. A computer program product comprising computer program code stored on a non-transitory computer-readable medium, which is readable by a computer, said computer program product is used for detection of operating conditions in a combustion engine, said computer program code comprising computer instructions to cause one or more computer processors to perform the operations of detecting pressure changes in a cylinder chamber of at least one cylinder in the engine, wherein the detection occurs by way of detecting movements of a cylinder head or of parts adjacent thereto in the engine, generated by pressure changes in said cylinder chamber.

26. (canceled)

27. An electronic control device for a combustion engine, comprising:
an execution means;
a non-transitory computer-readable data storage medium connected to the execution means; and
a computer program product comprising computer program code stored on said non-transitory computer-readable medium, which is readable by a computer, said computer program product is used for detection of operating conditions in a combustion engine, said computer program code comprising computer instructions to cause the execution means to perform the operations of detecting pressure changes in a cylinder chamber of at least one cylinder in the engine, wherein the detection occurs by way of detecting movements of a cylinder head or of parts adjacent thereto in the engine, generated by pressure changes in said cylinder chamber.

28. A device adapted to detect operating conditions in a combustion engine, and which device comprises:
a device, adapted to detect pressure changes in a cylinder chamber of at least one cylinder of the engine; and
at least one sensor element, arranged separately from said cylinder chamber on a part of a cylinder head or on parts adjacent thereto in the engine, and adapted to detect movements in said cylinder head or in parts adjacent thereto in the engine, generated by pressure changes in said cylinder chamber.

29. A motor vehicle comprising a device arranged to detect operating conditions of a combustion engine, and which device comprises:
a device adapted to detect pressure changes in a cylinder chamber of at least one cylinder in the engine; and
at least one sensor element, arranged separately from said cylinder chamber on a part of a cylinder head or on parts adjacent thereto in the engine, and adapted to detect propagated movements in said cylinder head or said parts, generated by pressure changes in said cylinder chamber.

30. A motor vehicle according to claim 29, wherein said vehicle is a wheeled motor vehicle or a boat or a crawler.
